(19) United States
(12) Patent Application Publication
(10) Pub. No.: US 2012/0325710 A1
(43) Pub. Date: Dec. 27, 2012

(54) DEMONSTRATIVE METHODS FOR DISPOSABLE PAPER PRODUCTS

(76) Inventors: Ann Marie Woulms, Milan, IN (US); Courtney Lynn Wargo, West Chester, OH (US); Alan Howard Ullman, Blue Ash, OH (US); Janese Christine O'Brien, Wyoming, OH (US)

(21) Appl. No.: 13/168,248

(22) Filed: Jun. 24, 2011

(51) Int. Cl. B65D 85/00; A47L 25/00; G09B 25/00

(52) U.S. Cl. 206/459.5; 434/365; 15/209.1

(57) ABSTRACT

A method for demonstrating the surface cleaning performance of a disposable paper product. The method comprising the steps of: selecting at least one test implement comprising disposable paper product; selecting at least one demonstration implement comprising a durable cloth substrate; selecting a testing surface; preparing at least one spill specimen, the spill specimen comprising a fluorescing or luminescent component; applying the spill specimen on a first portion and a second portion of the testing surface; wiping the spill specimen from the first portion of testing surface with the test implement; wiping the spill specimen from the second portion of testing surface with the demonstration implement; and, revealing by sufficient lighting means any of the fluorescing or luminescent component remaining on the testing surface.

### FIELD OF THE INVENTION

The present invention relates to methods for demonstrating surface cleaning performance or performance differences between two or more test implements such as paper towel products or cleaning implements and presenting the results to the consumer, e.g. evidencing the surface cleaning performance or performance differences to the consumer.

### BACKGROUND OF THE INVENTION

Consumers of disposable paper products such as paper towels and paper napkins continue to demand improved product performance. As a result, formulators and manufacturers continually try to improve upon paper product properties that are desired by consumers. However, even when a better product is formulated and manufactured, formulators face difficulty in communicating to the consumers, especially in a meaningful, clear and visual manner, that their paper product demonstrates improved or more effective performance, for example cleaning performance, compared to other paper products.

Accordingly, there is a need for a method for demonstrating to a consumer the cleaning advantages of using a disposable paper product as a cleaning implement.

Also there is a need for a method to demonstrate performance differences between cleaning implements such as paper towel products and/or durable implements, and clearly communicating these differences to the consumer.

### SUMMARY OF THE INVENTION

A method for demonstrating the surface cleaning performance of a disposable paper product is disclosed. The method comprising the steps of: selecting at least one test implement comprising disposable paper product; selecting at least one demonstration implement comprising a durable cloth substrate; selecting a testing surface; preparing at least one spill specimen, the spill specimen comprising a fluorescing or luminescent component; applying the spill specimen on a first portion and a second portion of the testing surface; wiping the spill specimen from the first portion of testing surface with the test implement; wiping the spill specimen from the second portion of testing surface with the demonstration implement; and, revealing by sufficient lighting means any of the fluorescing or luminescent component remaining on the testing surface.

In another method, the method comprises selecting at least one cleaning implement comprising a substrate selected from the group consisting of disposable paper product, nonwoven wipe and woven cloth; preparing at least one spill specimen, the spill specimen comprising a fluorescing or luminescent component; applying the spill specimens to a first testing surface;

wiping at least a portion of the first spill specimen from the testing surface with the cleaning implement to transfer at least a portion of the spill specimen to the cleaning implement; rinsing the cleaning implement to remove at least a portion of the transferred spill specimen; wiping the cleaning implement onto a second testing surface; and revealing by sufficient lighting means any of the fluorescing or luminescent component transferred to the second testing surface.

### BRIEF DESCRIPTION OF THE DRAWINGS

FIG. 1 is a schematic representation of an example of a method for demonstrating the surface cleaning performance of a test implement or for performance differences between two or more test implements, according to the present invention;

FIG. 2 is a schematic representation of a hand holding a paper towel product according to the present method;

FIG. 3 is a front view of an example of a package such as a paper towel product package according to the present invention;

FIG. 4 is a front view of an example marketing article according to the present invention; and

FIG. 5 is a photograph of the wiping step with a test or cleaning implement.

### DETAILED DESCRIPTION OF THE INVENTION

### Definitions

“Fiber” as used herein means an elongate particulate having an apparent length greatly exceeding its apparent diameter, i.e. a length to diameter ratio of at least about 10. Fibers having a non-circular cross-section are common; the “diameter” in this case may be considered the diameter of a circle having cross-sectional area equal to the cross-sectional area of the fiber. More specifically, as used herein, “fiber” refers to fibrous structure-making fibers. The present invention contemplates the use of a variety of fibrous structure-making fibers, such as, for example, natural fibers, including wood fibers, or synthetic fibers made from natural polymers and/or synthetic fibers, or any other suitable fibers, and any combination thereof.

As used herein, “fibrous structure products” or “disposable paper products” or “paper products” mean paper products comprising a fibrous structure, usually including cellulose fibers. In one embodiment, the products of the present invention include tissue-towel paper products, including paper toweling, facial tissue, bath tissue, table napkins, and the like. “Paper towels” and “paper towel products” as used herein include napkin products. The products of the present invention may be in any suitable form, such as in a roll, in individual sheets, in connected, but perforated sheets, in a folded format or even in an unfolded format.

“Fibrous structure” as used herein means a structure (web) that comprises one or more fibers. Nonlimiting examples of processes for making fibrous structures include known wet-laid fibrous structure making processes, air-laid fibrous structure making processes, meltblowing fibrous structure making processes, co-forming fibrous structure making processes, and spunbond fibrous structure making processes. Such processes typically include steps of preparing a fiber composition, oftentimes referred to as a fiber slurry in wet-laid processes, either wet or dry, and then depositing a plurality of fibers onto a forming wire or belt such that an embryonic fibrous structure is formed, drying and/or bonding the fibers together such that a fibrous structure is formed, and/or further processing the fibrous structure such that a finished fibrous structure is fanned. The fibrous structure may be a through-air-dried fibrous structure and/or conventionally dried fibrous structure. The fibrous structure may be creped or uncreped. The fibrous structure may exhibit differential density regions or may be substantially uniform in density. The fibrous structure may be pattern densified, conventionally felt-presses and/or high-bulk, uncompacted. The fibrous structures may be homogenous or multilayered in construction.

After and/or concurrently with the forming of the fibrous structure, the fibrous structure may be subjected to physical transformation operations such as embossing, calendaring, selfing, printing, folding, softening, ring-rolling, applying additives, such as latex, lotion and softening agents, combining with one or more other plies of fibrous structures, and the like to produce a finished fibrous structure product.

The disposable paper products of the present invention may exhibit a basis weight between about 10 g/m² to about 120 g/m² and/or from about 15 g/m² to about 110 g/m² and/or from about 20 g/m² to about 100 g/m² and/or from about 30 to 90 g/m². In addition, the paper towel product of the present invention may exhibit a basis weight between about 40 g/m² to about 120 g/m² and/or from about 50 g/m² to about 110 g/m² and/or from about 55 g/m² to about 105 g/m² and/or from about 60 to 100 g/m².

In one embodiment, the HFS value of a paper towel product may be from about 10 g/g to about 35 g/g, and/or from about 11 g/g to about 30 g/g, and/or from about 12 g/g to about 30 g/g and/or from about 14 g/g to about 28 g/g.

The disposable paper products of the present invention may exhibit a total dry tensile strength of greater than about 59 g/cm (150 g/in) and/or from about 78 g/cm (200 g/in) to about 394 g/cm (1000 g/in) and/or from about 98 g/cm (250 g/in) to about 335 g/cm (850 g/in). In addition, the paper towel product of the present invention may exhibit a total dry tensile strength of greater than about 196 g/cm (500 g/in) and/or from about 196 g/cm (500 g/in) to about 394 g/cm (1000 g/in) and/or from about 216 g/cm (550 g/in) to about 335 g/cm (850 g/in) and/or from about 236 g/cm (600 g/in) to about 315 g/cm (800 g/in). In one example, the paper towel product exhibits a total dry tensile strength of less than about 394 g/cm (1000 g/in) and/or less than about 335 g/cm (850 g/in).

In another example, the disposable paper products of the present invention may exhibit a total dry tensile strength of greater than about 315 g/cm (800 g/in) and/or greater than about 354 g/cm (900 g/in) and/or greater than about 394 g/cm (1000 g/in) and/or from about 315 g/cm (800 g/in) to about 1968 g/cm (5000 g/in) and/or from about 354 g/cm (900 g/in) to about 1181 g/cm (3000 g/in) and/or from about 354 g/cm (900 g/in) to about 984 g/cm (2500 g/in) and/or from about 394 g/cm (1000 g/in) to about 787 g/cm (2000 g/in).

The disposable paper products of the present invention may comprise additives such as softening agents, temporary wet strength agents, permanent wet strength agents, bulk softening agents, lotions, silicones, and other types of additives suitable for inclusion in and/or on paper towel products.

“Ply” or “plies” as used herein means an individual finished fibrous structure optionally to be disposed in a substantially contiguous, face-to-face relationship with other plies, forming a multiple ply (“multi-ply”) paper product. It is also contemplated that a single-ply product can effectively form two “plies” or multiple “plies”, for example, by being folded on itself.

“Machine Direction” or “MD” as used herein means the direction parallel to the flow of the fibrous structure through the papermaking machine and/or product manufacturing equipment. In one example, once incorporated into a paper product, the MD of the fibrous structure may be the MD of the paper product.

“Cross Machine Direction” or “CD” as used herein means the direction perpendicular to the machine direction in the same plane of the fibrous structure. In one example, once incorporated into a paper product, the CD of the fibrous structure may be the CD of the paper product.

“Indicia” as used herein means an indicator that conveys information to a consumer.

“Textual indicia” as used herein means text indicia, such as a word and/or phrase that conveys information to a consumer. In one example, a paper product is housed in a package comprising a textual indicia.

“Brand name” as used herein refers to a single source identifier, in other words, a brand name identifies a product and/or service as exclusively coming from a single commercial source (i.e., company). An example of a brand name is Charmin®, Bounty®, which are also trademarks. Brand names are nonlimiting examples of textual indicia. The paper products of the present invention may be marketed and/or packaged under a common brand name (i.e., the same brand name, such as Bounty®). In addition to the brand name, a product descriptor may also be associated with the paper products.

“Non-textual indicia” as used herein means non-text indicia that conveys information about a product to a consumer through a consumer's senses. In one example, non-textual indicia may convey, even intuitively, to a consumer through sight (visual indicia), through touch (texture indicia) and/or through smell (scent indicia), and combinations thereof.

Nonlimiting examples of non-textual indicia include pictures, graphs, drawings, representations such as product representations comparing two or more products, images, icons, colors, textures, patterns, such as emboss patterns and/or emboss pattern images, character representations, action representations, and mixture thereof.

As used herein, “basis weight” is the weight per unit area of a sample reported in lbs/3000 ft² or g/m². The basis weight is measured herein by the basis weight test method described in the Test Methods section herein.

As used herein, “cleaning implement” is a handheld implement intended for wiping, absorbing, or cleaning purposes and includes disposable paper products and durable cleaning implements.

As used herein, “texture” means any pattern present in the fibrous structure product. For example, a pattern may be imparted to the fibrous structure during the fibrous structure-wet making process, such as during a through-air-drying step. A pattern may also be imparted to the fibrous structure by embossing or brushing the finished fibrous structure during the converting process and/or by any other suitable process known in the art.

### Method for Demonstrating Surface Cleaning Performance (Surface Cleaning Test Method)

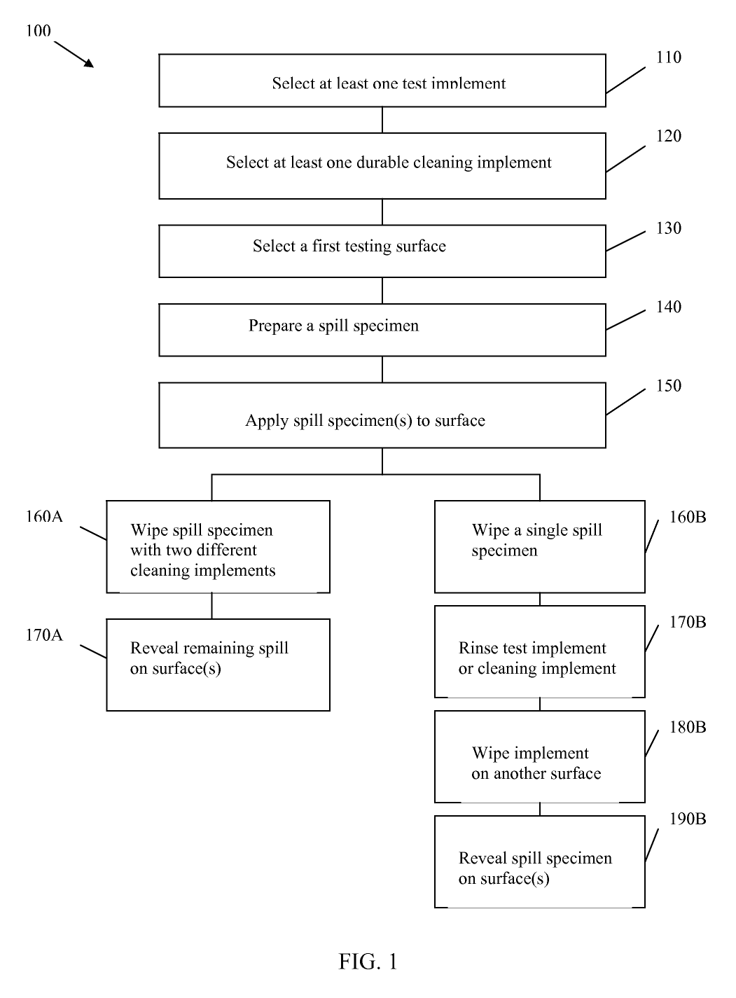

A schematic illustration of the steps involved in the surface cleaning test method of the present invention is shown in FIG. 1. The overall demonstration of surface cleaning test method 100 is composed of a series of steps, some of which are sequential steps, selected to mimic how some consumers use cleaning implements, e.g. disposable paper products and durable cleaning implements (also referred to as durable cleaning products), in real life conditions to clean spills or messes on surfaces, for example hard surfaces, countertops, etc. Further, the method steps are selected to exhibit and communicate the presence of and/or the transfer of spill material from one surface to another via cleaning implements.

Disposable paper products include paper towels, such as BOUNTY® brand paper towels from The Procter & Gamble Co. Durable cleaning implements include dish towels, hand cloths, dish cloths, rags and other products comprising washable woven fabric substrates, as well as sponges, wipers, scrubbing brushes, and the like. Durable cleaning implements differ from disposable paper products in that durable cleaning implements are intended to be used multiple times prior to eventual disposable. Durable cleaning implements can be rinsed, washed, cleaned, and reused multiple times prior to eventual wearing out and disposal.

The overall method 100 may be done in a comparative manner so that the consumer can evaluate how different products, within an array of branded products, or how products associated with different brands, will perform under similar use conditions.

The first step 110 of the process comprises selecting at least one disposable paper product test implement. “Test implement” as used herein means a cleaning implement suitable for cleaning surfaces found in a consumer's home, and includes disposable implements such as a paper towel products and napkins, as well as durable implements such as dishcloths, sponges, rags, brushes, etc. In an embodiment the test implement is a first disposable paper product.

The second step 120 comprises selecting at least one demonstration implement, which can be either a second disposable paper product or a durable cleaning implement.

The third step 130 comprises selecting a first testing surface (in another embodiment a second surface, which can be a second testing, surface will be introduced). In an embodiment the first testing surface comprises a solid surface countertop, hard surface flooring material such as vinyl, laminate, tile, synthetic, or hardwood flooring, glass, ceramic, porcelain, plastic, or other generally smooth surface of the type typically found in the kitchen area or other areas of a home, and combinations thereof. In an embodiment the first testing surface is intended to be or to mimic the surfaces that a consumer would want to clean in the kitchen, bath, or other areas of their home. In one embodiment the first testing surface may be a 2 foot by 2 foot size sample of a Formica® surface, which comprises a high pressure laminated plastic sheet of synthetic resin employed as a heat resistant and chemical resistant surface for tabletop and countertops. In an embodiment the first testing surface should be cleaned prior to each use or between each application of spill specimen, for example with water or isopropal alcohol to strip off any residue of the spill specimen such as surfactants, etc.

The forth step 140 comprises preparing at least one spill specimen for testing with the test implements. In an embodiment, the spill specimen is intended to have a composition that mimic common kitchen spills, and may have components selected from the group consisting of solid particulates, fluids, viscous fluids, and combinations thereof. In an embodiment the spill specimen may be selected from the group consisting of food, such as ketchup, spaghetti sauce, taco sauce, a mixture of liquid coffee plus coffee grounds, jam, jelly, honey, salad dressing, Kool-Aid®, sauces, juices, milk, pasta, etc., mud, water, pet messes, pet hair, and combinations thereof.

In an embodiment, the spill specimen composition can comprise a component that is invisible under ordinary sunlight or ordinary indoor room lighting, but is visible under special lighting, such as ultra-violet (UV), infra-red (IR), or black lighting. For example, the spill specimen can have fluorescing materials or chemical luminescent materials in an amount sufficient to be visible to the unaided naked human eye when illuminated with the appropriate lighting means, which can include any of known IR lights, UV lights, black lights, or other lights emitting wavelengths suitable for making visible materials which are otherwise invisible under normal lighting conditions.

In one embodiment, the spill specimen can have mixed into it GLO GERM materials available from www.glogerm.com, and which are visible under UV lighting. GLO GERM materials can be in powder form, gel form, and oil form. Sufficient UV light means can be handheld, screw-in, or plug in, such as available from GLO GERM under the part codes U10, GBKB, and 8LS, respectively.

In one embodiment, the spill specimen can have mixed into it GLOBRIGHT Simulation Germ Juice or Germ Juice Powder or Simulation Germ Powder, all available from www.globright.com, and which are visible under UV lighting.

In an embodiment, the spill specimen can be a fluid or viscous fluid such as yogurt having mixed 1 part Glo Gel from GLO GERM to 2 parts fluid (e.g., yogurt). Sufficient UV light means can include the 801 Light Stick (Code 8LS) also available from GLO GERM.

In an embodiment, the spill specimen can be a fluid or viscous fluid such as yogurt having mixed 1 part GLOBRIGHT Simulation Germ Juice to 2 parts fluid (e.g., yogurt). Sufficient UV light means can include the SuperMax 1 LED light available from GLOBRIGHT.

Other materials known to fluoresce and which can be the fluorescing or luminescent component of the spill specimen include petroleum jelly, tonic water, chlorophyll, antifreeze, some laundry detergents and other cleansers, and some dissolved vitamins, such as vitamin A, niacin, thiamine, and riboflavin. In an embodiment a cleaning implement can be new or unwashed, so that fluorescing residue is not left in the implement.

In an embodiment the present invention makes use of chemicals to cause luminescence (i.e., chemiluminescence). In an embodiment a chemical reaction causes visible light emission when luminol or an equivalent chemical comes in contact with, for example, iron as found in hemoglobin. In an embodiment chicken juice (raw chicken drippings) can be a portion of the spill specimen, and luminol can be used to reveal the presence of the chicken juice on the testing surface, other surface(s), or the cleaning implement. In the method below, whenever the method states the use of lighting means to reveal the presence of fluorescing materials, the method step involved can alternatively be by use chemistry to induce light emission that can then be viewed by various lighting means, including ordinary incandescent lighting or daylight.

In an embodiment if more than one spill specimen is prepared, the individual spill specimens can comprise substantially similar volume and/or composition. In an embodiment the spill specimens comprise from about 3% to about 95% or from about 5% to about 40%, moisture such as water. In one embodiment the spill specimen comprises at least some solid particulates in combination with liquids. In another embodiment the spill specimen may comprise solid particulates, in an embodiment from about 0.5% to about 60% or from about 0.5% to about 30%, or about 1% to about 3% by weight of the spill specimen, of solid particles. In an embodiment the volume of spill specimen is from about 5 ml to about 20 ml, or from about 6 ml to about 10 ml. A 10 ml spill specimen size is a typical volume for a spill typically found in the kitchen area, as reported by some consumers. In an embodiment each spill specimen comprises from about 1 gram to about 25 grams or about 2 grams to about 20 grams, of solid particulates, fluids, viscous fluids, and combinations thereof.

A fifth step 150 comprises applying the spill specimen(s) to the first testing surface. In an embodiment the spill specimen is applied to one portion of the first testing surface. In an embodiment, the spill specimen is applied to two portions of the first testing surface in substantially equal amounts.

A sixth step 160 comprises optionally one of two steps involving wiping the spill specimen on the first testing surface with a test implement and/or a cleaning implement. In an embodiment at step 160A two separate spill specimens of substantially equal composition and size can be wiped using two different cleaning implements. A first spill specimen on a first portion of the testing surface can be wiped with a test implement such as a disposable paper product, and a second spill specimen on a second portion of the testing surface can be wiped with a demonstration implement such as a second disposable paper product or a durable cleaning product.

In optional sixth step 160B a single spill specimen is used. The single spill specimen can be wiped with either a test implement or a durable cleaning implement.

Subsequent steps will be described based on whether the step follows either step 160A or step 160B, with each subsequent step using a consistent letter, A or B. Thus, step 170A follows step 160A, and 170B follows step 160B, and so on.

In a seventh step 170A sufficient lighting means is used to reveal at least a portion of the test spill remaining on the testing surface and/or to reveal at least a portion of the test spill picked up by the cleaning implement. In an embodiment where the entire spill specimen appears to the unaided naked eye under normal lighting conditions to be wiped off of the testing surface, UV lighting can be used to fluoresce any remaining fluorescing components of any remaining spill specimen, indicating that what appears to be a clean testing surface is not actually clean. A comparison between a test implement and another test implement (e.g., two different brands of paper towels), or a demonstration implement (which can be a disposable paper product or a durable cleaning implement) can reveal their respective cleaning abilities. Thus, this step reveals to a consumer, for example, that two cleaning implements that both appear to clean equally well, may not clean equally well.

In a seventh step 170B, the single implement, either a test implement such as a disposable paper product or a demonstration implement such as a durable cleaning implement, can be rinsed clean to remove the wiped spill specimen. In an embodiment, the rinsing step can be under a stream of water from a typical kitchen or bathroom faucet, with a typical rinsing and squeezing action as is typical of hand rinsing to remove wiped up messes. In an embodiment, the rinsing can include three rinses and squeezes in a period of about 10-30 seconds.

In an eighth step 180B, the rinsed cleaning implement can be wiped on another surface, including one's hand, fingers, or other skin, door handles, cutting board, refrigerator surface, floor, baby toys, or a second, clean, testing surface. Wiping can be by a typical hand motion used to wipe a spill with hand pressure on a kitchen or bathroom counter.

In a ninth step 190B, a sufficient lighting means, such as UV lighting can be used to fluoresce, and therefore reveal, any fluorescing components transferred to another surface, including any remaining fluorescing components of any remaining spill specimen on a second surface, such as a second testing surface, thereby indicating that what appears to be a clean testing surface is not actually clean. In this step the sufficient lighting means reveals a portion of the spill specimen that remained in the rinsed cleaning implement and was subsequently transferred to a clean test surface. Thus, this step reveals to a consumer, for example, that what appears to be a clean, rinsed, cleaning implement is not actually clean, and germs, represented by the fluorescing or luminescent component of the spill specimen, can be transferred to one's hand, fingers, or other skin, door handles, cutting board, refrigerator surface, floor, baby toys, or otherwise clean countertops, etc., by subsequent wiping motions. In an embodiment the transfer of spill specimen can be due to a portion of the spill specimen soaking through the cleaning implement onto a surface which can be the user's fingers.

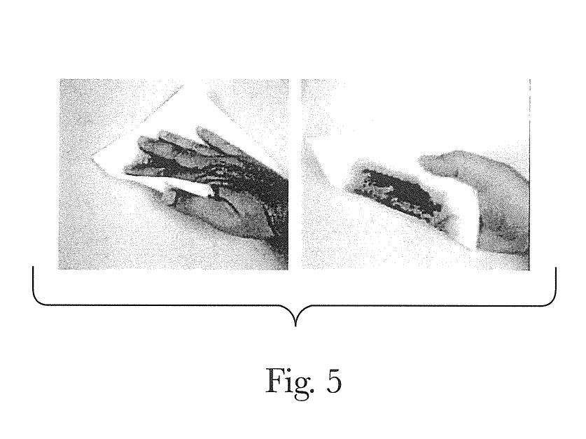

According to FIG. 5, showing a wiping step, in an embodiment, the wiping step comprises holding the test or cleaning implement at an angle relative to the testing surface while wiping the spill specimen or residual spill specimen. In an embodiment holding the demonstration implement at a greater angle relative to the testing surface will enable better viewing of the adherence of the residual spill specimen to the demonstration implement and the volume of the residual spill specimen that attaches to the demonstration implement.

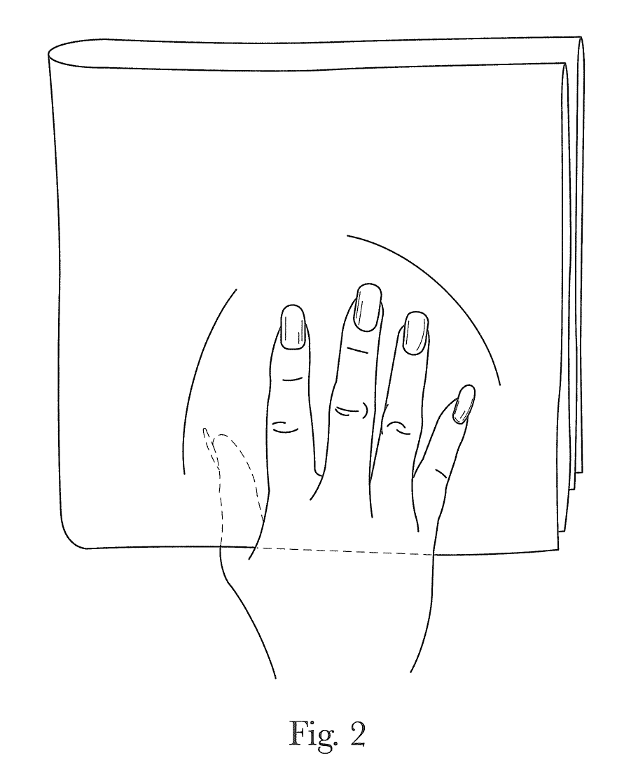

In an embodiment prior to wiping each spill specimen on the testing surface with the test or cleaning implements, if possible, the wiping implement is prepared such as folding into a particular configuration. For paper towels form a roll, because the first two sheets of a new roll of paper towel product and the last two sheets on new roll of paper towel product contain glue, one may avoid using these sheets. After at least one paper towel is selected from the roll of paper towel product, then the sheet may be folded. FIG. 2 is a representation of how a sheet of a folded paper towel product may be held by a human hand for the wiping step, and illustrates an embodiment of how to prepare the paper towel product for use in the test method herein. For example, place the sheet on a table so that the side facing outwards on the roll faces downwards. Then fold the sheet in half, left to right, and fold the sheet again in half from top to bottom. As shown in FIG. 2, the user can then grasp the folded towel in his or her right hand, between the thumb and the forefinger, by the edge away from the open-perforated, folded edge. The fingers may be spread over the folded sheet of the paper towel product, wherein the folded side of the sheet may contact the spill specimen, first, during the wiping step. This same preparation procedure may be used for preparation of a suitable cleaning implement.

In an embodiment one of the spill specimens on the testing surface is wiped with the first test implement such as a first paper towel product wherein at least some of the spill specimen adheres to the first test implement. Then a second spill specimen on the testing surface is wiped with a second test implement such as a cleaning implement such as a dishcloth, wherein at least some of the spill specimen adheres to the dishcloth. In another embodiment the test implements comprise a first branded paper towel product and a second branded paper towel product having a different brand name than the first paper towel product.

In an embodiment from about 50% to about 100% or from about 90% to about 100% of the spill specimen adheres to the test implement after the wiping step. In an example the wiping step includes placing the test implement such as a paper towel product flat on the testing surface. In an example the tester (human tester or machine tester such as a robotic wiping simulator) wipes the paper towel product for one wipe cycle or alternatively, back and forth (side to side or up and down motion) across the testing surface. For example, the wiping motion should move the test implement across the testing surface a distance of from about 4 inches to about 30 inches or from about 20 inches to about 28 inches, for about 0.5 seconds to about 6 seconds to complete one wiping cycle. In one embodiment one wiping cycle comprises either one continuous wipe cycle or from about 2 to about 4 cycles (back and forth) moving the test implement a distance from about 4 inches to about 30 inches each way. In one embodiment the wiping cycle is one continuous cycle with a distance of about 22 inches to about 26 inches. In an embodiment the entire hand may maintain contact with the test implement and apply a constant pressure of about 0.15 to about 0.6 pounds per square inch (psi) or about 0.50 psi to about 0.5 psi. For example, a total of from about 1 to about 4 wipe cycles are completed for each test implement being tested, taking a total of about 1 second to about 6 seconds to complete per wiping cycle. The wiping step using the test implement may be repeated (e.g. 5 times) to provide a more accurate average measure of spill specimen clean up.

In an embodiment a separate spill specimen is used for each test implement. In an embodiment the wiping step for the first test implement and a second test or cleaning implement occurs simultaneously or is synchronized in a side-by-side comparison.

The average pressure applied by consumers when performing a cleanup on a solid surface is from about 0.2 psi to about 0.4 psi. This pressure may be determined using a Force Sensing Array, Mat Model 1010, produced by Vista Medical, Winnipeg, MB, Canada. The pad is a relatively large pad (40.64 cm×40.64 cm) (16″×16″) with an array of 256 (2.54 cm×2.54 cm) (1″×1″) resistors that directly measure the pressure over the entire wipe area in 0.1 second intervals. Calibration is accomplished using a pressure bladder, providing uniform pressure across the array. Average pressures are summarized in Table 1 below.

TABLE 1
Average pressure used by consumers to clean up spills and marks

| Description of spill and instructions | Base size | Average Pressure (psi) |
|---|---|---|
| 15 ml water, vinyl floor | 19 | 0.3 |
| Instructions; wipe spill | | |
| 5 ml jam, vinyl floor | 19 | 0.4 |
| Instructions; wipe spill | | |

In an embodiment, after wiping each spill specimen on the testing surface with a test implement each residual spill specimen left on the testing surface is wiped again with a second implement (either test or cleaning implement) wherein at least some of the residual spill specimen adheres to the second implement. The wiping motion and wiping cycle, as indicated herein, may also apply to the wiping step using the demonstration implement.

In one embodiment the cleaning implement is a white colored cloth, such as a white glove, made from a fabric or other paper material, white paper towel, white filter paper, or white dishcloth. Due to potential for evaporation of the spill specimen, this second wiping step, in an embodiment, is performed relatively quickly after the first wiping step, for example within about 5 seconds to about 60 seconds or from about 10 seconds to about 30 seconds after the first wiping step with the test implements.

In an embodiment the demonstration method of the present invention may be aided by the selection of a testing surface, test implements, demonstration implements, and/or spill specimens, that comprise visual contrast. As used herein “visual contrast” means density, shading, or color variation or contrast perceived by the human eye. For example, the testing surface, demonstration implement, and/or the spill specimen may be different colors, different color shades, comprise different light reflective properties, comprise different fluorescent properties, etc., and combinations thereof. In an example, the demonstration implement or the testing surface maybe white and the spill specimen may be orange or red.

One may demonstrate or measure the performance differences or results by determining the amount of the spill specimen that is picked up by the test implement. For example, the spill specimen may be weighed prior to placing on the testing surface. The dry test implements are then weighed. The spill specimen on the testing surface is wiped with the test implement. Thereafter the test implements are reweighed. The amount of the spill specimen picked up by each test implement may then be determined by subtracting the weight of the spill specimen from the weigh of the testing substrate after wiping the spill specimen. A four place analytical balance that is calibrated, may be used to determine these weights, for example, analytical balance, Model Number XS204, from Mettler Toledo, (accuracy minimum graduation of 0.0001 g., max load of 220 g) may be used to determine the weights of the spill specimens, test implements, etc.

An optional method step is presenting the results of the method of demonstrating surface cleaning to consumers. Nonlimiting examples of ways that the results may be presented to consumers include visually, numerically and/or graphically.

Visually presenting the results may include conducting a simulated, in-use performance of the test method for the paper product in the presence of one or more consumers and then showing the results; showing the results to a consumer in person; and/or representing the results in an image, such as a photograph or video, to the consumer.

Visually presenting the results may include showing the consumer the demonstration implement(s) (e.g. which is a visual representation) after wiping the residual spill specimen to show the amount of spill specimen remaining on the testing surface after the spill specimens are wiped with each test implement. In an embodiment by providing this visual representation to consumers, the consumers are able to better understand the cleaning performance characteristics of the test implements.

Numerically presenting the results to consumers may include: providing the volume and/or weight of the spill specimen that is picked up by each test implement or providing the volume and/or weight of the spill specimen that is left on the testing surface after wiping the testing surface with the test implements, to the consumers. Numerically presenting the results to consumers may also include showing the consumers an image or icon that indicates that the testing surface is 3 times, 4 times, and/or 5 times, cleaner (e.g. from greater than about 1 to about 50 times cleaner, or about 2 to about 20 times cleaner) than prior to use of the test implement or from greater than about 1 to about 20 times cleaner than another test implement when 2 or more test implement are tested together. Numerically presenting the results to consumers may also include an image or icon that indicates that the test implement removed a certain percentage of spill specimen on the testing surface or only left a certain percentage of the spill specimen on the test surface.

Graphically presenting the results to consumers may include providing a graph that evidences the results.

The results may be presented to the consumers in one or more of the following ways: airing a television commercial comprising the results; placing the results on the Internet; distributing a print advertisement comprising the results; distributing or presenting the results on paper towel product packages, presenting the results on the paper towel product (for example by printing the results on the paper towel product and/or by embossing the results on the paper towel product, displaying the results on an in-store display or on in store advertising materials; and/or displaying the results on a billboard.

The results may be obtained from the surface cleaning test method described herein.

### Paper Product Package

In an embodiment the present invention relates to a paper product package comprising a disposable paper product and packaging comprising textual or non-textual indicia that communicates to a consumer that the disposable paper product is capable of, via the method herein, communicated surface cleaning performance or surface cleaning performance differences from another test implement.

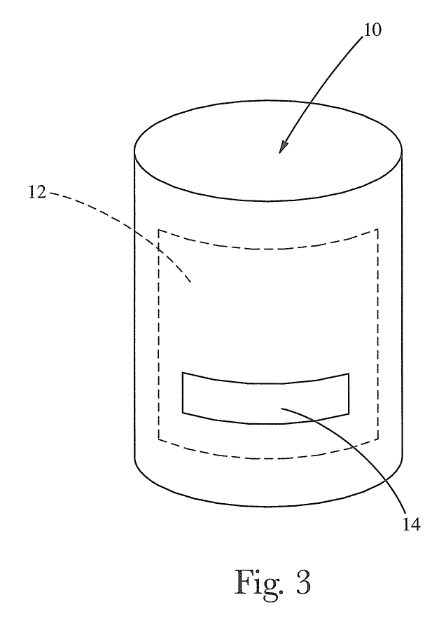

As shown in FIG. 3, a paper product package 10 housing a disposable paper product (that can be identical in properties to the test implement) 12 of the type tested according the method of the present invention, wherein the package 10 may comprise indicia 14, that may be textual or non-textual indicia. The indicia 14 communicates to a consumer that the disposable paper product (such as a paper towel product) 12 is of the type capable of the communicated surface cleaning performance or a surface cleaning performance that is different from another test implement. The method of the present invention may be recorded via photography, video, or film or through the use of animation techniques. The indicia described herein may be an individual image from this recording or an individual frame from this recording.

In an example, the paper towel product package 10 may comprise indicia 14 selected from the group consisting of: pictures, graphs, drawings, representations, images, icons and combinations thereof.

### Marketing Article

In an embodiment the present invention also relates to a marketing article comprising textual or non-textual indicia that communicates to a consumer that a paper product exhibits, via the method herein, surface cleaning performance or surface cleaning performance differences from another test implement.

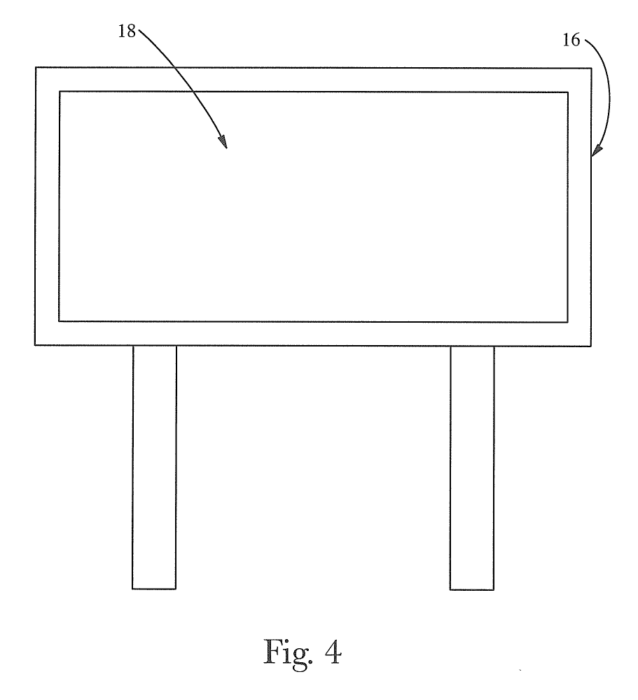

As shown in FIG. 4, a marketing article, for example a billboard, 16 may comprise indicia 18, that may be textual or nontextual indicia, that communicates to a consumer that a test implement, such as a paper towel product, exhibits surface cleaning performance or surface cleaning performance differences from another test implement. In an embodiment the indicia 14 and the indicia 18 are substantially similar and the marketing article 16 is utilized in association the package 10.

The marketing article 16 may comprise indicia 18 selected from the group consisting of: pictures, graphs, drawings, representations, images, icons and combinations thereof.

The marketing article 16 may be selected from the group consisting of: print advertisements, in-store display advertisements, billboard advertisements, television advertisements, Internet advertisements and combinations thereof.

### Test Methods

Unless otherwise indicated, all tests described herein including those described under the Definitions section and the following test methods are conducted on test implements, samples, fibrous structure samples and/or paper towel product samples and/or handsheets that have been conditioned in a conditioned room at a temperature of 73° F.±4° F. (about 23° C.±2.2° C.) and a relative humidity of 50%±10% for 4 hours prior to the test. Further, all tests may be conducted in such conditioned room.

### Basis Weight Method:

Basis weight is measured by preparing one or more samples of a certain area (m²) and weighing the sample(s) of a fibrous structure according to the present invention and/or a paper towel product comprising such fibrous structure on a top loading balance with a minimum resolution of 0.01 g. The balance is protected from air drafts and other disturbances using a draft shield. Weights are recorded when the readings on the balance become constant. The average weight (g) and the average area of the samples (m²) are calculated. The basis weight (g/m²) is calculated by dividing the average weight (g) by the average area of the samples (m²).

### HFS (Horizontal Full Sheet)

The Horizontal Full Sheet (HFS) test method determines the amount of distilled water absorbed and retained by the paper towel product herein or test implement. This method is performed by first weighing a sample of the paper to be tested (referred to herein as the “Dry Weight of the paper”), then thoroughly wetting the paper, draining the wetted paper in a horizontal position and then reweighing (referred to herein as “Wet Weight of the paper”). The absorptive capacity of the paper is then computed as the amount of water retained in units of grams of water absorbed by the paper.

The apparatus for determining the HFS capacity of paper comprises the following: An electronic balance with a sensitivity of at least ±0.01 grams and a minimum capacity of 1200 grams. The balance should be positioned on a balance table and slab to minimize the vibration effects of floor/benchtop weighing. The balance should also have a balance pan to be able to handle the size of the paper tested. The balance pan can be made out of a variety of materials. Plexiglas is a common material used.

A sample support rack and sample support cover is also required. Both the rack and cover are comprised of a lightweight metal frame, strung with 0.012 in. (0.305 cm) diameter monofilament so as to form a grid of 0.5 inch squares (1.27 cm2). The size of the support rack and cover is such that the sample size can be conveniently placed between the two.

The HFS test is performed in an environment maintained at 23±1° C. and 50±2% relative humidity. A water reservoir or tub is filled with distilled water at 23±1° C. to a depth of 3 inches (7.6 cm).

The paper to be tested is carefully weighed on the balance to the nearest 0.01 grams. The dry weight of the sample is reported to the nearest 0.01 grams. The empty sample support rack is placed on the balance with the special balance pan. The balance is then zeroed (tared). The sample is carefully placed on the sample support rack. The support rack cover is placed on top of the support rack. The sample (now sandwiched between the rack and cover) is submerged in the water reservoir. After the sample has been submerged for 60 seconds, the sample support rack and cover are gently raised out of the reservoir.

The sample, support rack and cover are allowed to drain horizontally for 120±5 seconds, taking care not to excessively shake or vibrate the sample. Next, the rack cover is carefully removed and the wet sample and the support rack are weighed on the previously tared balance. The weight is recorded to the nearest 0.01 g. This is the wet weight of the sample.

The grams of water per paper sample absorptive capacity of the sample (or HFS value) is defined as (Wet Weight of the paper-Dry Weight of the paper).

### Dry Tensile Strength Test Method:

One (1) inch by five (5) inch (2.5 cm×12.7 cm) strips of fibrous structure and/or paper towel product are provided. The strip is placed on an electronic tensile tester Model 1122 commercially available from Instron Corp., Canton, Mass. in a conditioned room at a temperature of 73° F.±4° F. (about 28° C.±2.2° C.) and a relative humidity of 50%±10%. The crosshead speed of the tensile tester is 2.0 inches per minute (about 5.1 cm/minute) and the gauge length is 4.0 inches (about 10.2 cm). The Dry Tensile Strength can be measured in any direction by this method. The “Total Dry Tensile Strength” or “TDT” is the special case determined by the arithmetic total of MD and CD tensile strengths of the strips.

The sample is tested in two orientations, referred to here as MD (machine direction, i.e., in the same direction as the continuously wound reel and forming fabric) and CD (cross-machine direction, i.e., 90° from MD). The MD and CD wet tensile strengths are determined using the above equipment and the Total Wet Tensile is determined by taking the sum of these two values.

### Test Method Equipment, and Process

The following is a description of a test stand, test specimen, and cameras/lighting that can be used in the method of the present invention.

Test Stand

A portable test stand can be designed to provide consistent ultraviolet illumination over common kitchen surfaces and sinks. The illumination can be used to detect, reveal, and/or allow inspection of any residual or transferred test specimen having as a component a fluorescing material. The test stand can consist of four support legs made from 1×1×19 inch solid T-Slotted extruded aluminum framing (available from McMaster-Carr, Chicago, Ill. 60680-4355, part number 47065T101). The horizontal top of the test stand can consist of one sheet of 0.25 inch of tinted polycarbonate sheet (Lexan™, GE Structured Products), approximately 18×24 inches (available from Modern Plastics, Shelton Connecticut 06484 USA), and can be attached to the four support legs using appropriate fittings and brackets for aluminum T-Slotted framing. The sufficient lighting means can be an ultraviolet light source such as a UVP brand Transilluminator (available from UVP, LLC, Upland Calif. 91786, model TL-33), which can be removably attached to the lower surface of the polycarbonate sheet and mounted so that the ultraviolet light shines down towards the surface supporting the test stand. The configuration of the test stand can be such that the light source surface of the Transilluminator is approximately 13 inches from the surface being illuminated.

Camera

A Cannon 5D M2 digital camera (Cannon USA Inc., Ridgefield Park, N.J. 07660), can be used to capture both still images and video pictures of any sufficiently lighted residual fluorescent materials. Images and video pictures can be used for qualitative comparison of residual or transferred fluorescent materials. For still images, the ISO can be set at ˜6400 and the aperture of the camera can be adjusted so that the intensity of the fluorescence picked up by the camera is similar in intensity to that seen with the human eye under the same conditions. The camera may also be used to capture video images of the cleaning process and/or residual fluorescing materials using an ISO 6400, 30 frames/second capture rate. The lens aperture can be adjusted so that the video image is consistent with that seen with the human eye. Room lighting can be minimized so that the test operator can see the testing surface to be cleaned while at the same time the UV camera can detect the fluorescence associated with test specimen.

Spill Specimen Preparation

Some foodstuffs already contain ingredients with fluorescent properties. Some of the fluorescent ingredients are added for perceived medicinal or flavor benefits, such as quinine in tonic water. For the evaluation spill specimens lacking in fluorescent properties, such as yogurt, a fluorescent additive such as GloGerm Gel (available from GloGerm™, Moab, Utah, 84532, product code GGG80) can be added to the foodstuff. A 2:1 ratio of yogurt to GloGerm Gel has been found to be appropriate for evaluation of cleaning performance and residual transfer of spill specimens.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for demonstrating the surface cleaning performance of a disposable paper product comprising the steps of:
selecting at least one test implement comprising a first disposable paper product;
selecting at least one demonstration implement comprising either a second disposable paper product or a durable cleaning implement;
selecting a testing surface;
preparing at least one spill specimen, said spill specimen comprising a fluorescing or luminescent component;
applying said spill specimen on a first portion and a second portion of said testing surface;
wiping said spill specimen from said first portion of testing surface with said test implement;
wiping said spill specimen from said second portion of testing surface with said demonstration implement; and,
revealing by sufficient lighting means any of said fluorescing or luminescent component remaining on said testing surface.

2. The method according to claim 1 wherein the test implement comprises a paper towel product or a paper napkin.

3. The method according to claim 1 wherein the testing surface comprises a solid surface countertop, flooring material, glass, ceramic, porcelain, tile, plastic, and combinations thereof.

4. The method according to claim 1 wherein the step of revealing comprises showing any of said fluorescing or luminescent component remaining on said testing surface by airing it in a television commercial.

5. The method according to claim 1 wherein the step of revealing comprises showing any of said fluorescing or luminescent component remaining on said testing surface by presenting it on the Internet.

6. The method according to claim 1 wherein the step of revealing comprises showing any of said fluorescing or luminescent component remaining on said testing surface by presenting it in a print advertisement.

7. The method according to claim 1 wherein the step of revealing comprises showing any of said fluorescing or luminescent component remaining on said testing surface by presenting it on a paper towel product package.

8. The method according to claim 1 wherein the step of revealing comprises showing any of said fluorescing or luminescent component remaining on said testing surface by presenting it on an in-store display.

9. The method according to claim 1 wherein the step of revealing comprises showing any of said fluorescing or luminescent component remaining on said testing surface by presenting it on a billboard.

10. The method according to claim 1 wherein the wiping steps comprises the use of a robotic simulated, in-use wiping process.

11. A method for demonstrating the surface cleaning performance of a cleaning implement comprising the steps of:
selecting at least one cleaning implement comprising a substrate selected from the group consisting of disposable paper product and durable cleaning implement;
preparing at least one spill specimen, said spill specimen comprising a fluorescing or luminescent component;
applying said spill specimens to a first testing surface;
wiping at least a portion of said first spill specimen from said testing surface with said cleaning implement to transfer at least a portion of said spill specimen to said cleaning implement;
rinsing said cleaning implement to remove at least a portion of said transferred spill specimen;
wiping said cleaning implement onto a second surface; and
revealing by sufficient lighting means any of said fluorescing or luminescent component transferred to said second testing surface.

12. The method according to claim 11 wherein the cleaning implement comprises a paper towel product.

13. The method according to claim 11 wherein the testing surface comprises a solid surface countertop, flooring material, glass, ceramic, porcelain, tile, plastic, and combinations thereof.

14. The method according to claim 11 wherein the step of revealing comprises showing any of said fluorescing or luminescent component remaining on said testing surface by airing it in a television commercial.

15. The method according to claim 11 wherein the step of revealing comprises showing any of said fluorescing or luminescent component remaining on said testing surface by presenting it on the Internet.

16. The method according to claim 11 wherein the step of revealing comprises showing any of said fluorescing or luminescent component remaining on said testing surface by presenting it in a print advertisement.

17. The method according to claim 11 wherein the step of revealing comprises showing any of said fluorescing or luminescent component remaining on said testing surface by presenting it on a paper towel product package.

18. The method according to claim 11 wherein the step of revealing comprises showing any of said fluorescing or luminescent component remaining on said testing surface by presenting it on an in-store display.

19. The method according to claim 11 wherein the step of revealing comprises showing any of said fluorescing or luminescent component remaining on said testing surface by presenting it on a billboard.

20. A paper product package comprising a paper towel product and a packaging comprising a textual or non-textual indicia that communicates to a consumer by showing fluorescing or luminescent images related to properties of said paper toweling product surface cleaning performance or surface cleaning performance differences from another test substrate.

21. The paper towel product package according to claim 20 wherein the indicia is selected from the group consisting of: pictures, graphs, drawings, representations, images, icons and mixtures thereof.

22. A marketing article comprising a textual or non-textual indicia that markets by communicating fluorescing or luminescent images related to properties of a paper toweling product surface cleaning performance or surface cleaning performance differences from another test substrate.

23. The marketing article according to claim 22 wherein the indicia is selected from the group consisting of: pictures, graphs, drawings, representations, images, icons and combinations thereof.

24. The marketing article according to claim 22 wherein the marketing article is selected from the group consisting of: print advertisements, in-store display advertisements, billboard advertisements, television advertisements, Internet advertisements and combinations thereof.
